(19) United States
(12) Patent Application Publication
(10) Pub. No.: US 2025/0327903 A1
(43) Pub. Date: Oct. 23, 2025

(54) MULTI-RANGE DETECTION LIDAR SENSOR

(71) Applicant: HL KLEMOVE CORPORATION, Incheon (KR)

(72) Inventor: Hyuk RYU, Incheon (KR)

(21) Appl. No.: 19/061,546

(22) Filed: Feb. 24, 2025

(30) Foreign Application Priority Data
Apr. 18, 2024 (KR) 10-2024-0052106

(51) Int. Cl. G01S 7/481; A47L 9/00; A47L 9/28; A47L 11/40; G01S 17/931

(52) U.S. Cl. CPC G01S 7/4817; A47L 9/009; A47L 9/2805; A47L 11/4011; A47L 11/4061; G01S 17/931; A47L 2201/04

(57) ABSTRACT

Disclosed is a multi-range detection lidar sensor capable of detecting a plurality of detection regions using one lidar sensor. The multi-range detection lidar sensor includes a laser projector for projecting laser, a laser scanner for refracting the laser projected by the laser projector in any one angle range of a first vertical angle range and a second vertical angle range and scanning the laser, a receiver for receiving the laser projected by the laser projector and reflected by a target, and a controller for controlling the laser projector, the receiver, and the scanner.

### CROSS-REFERENCE TO RELATED APPLICATION

This application claims priority to and the benefit of Korean Patent Application No. 10-2024-0052106, filed on Apr. 18, 2024, the disclosures of which are incorporated herein by reference in its entirety.

### BACKGROUND

### Technical Field

The present disclosure relates to a lidar sensor, and more specifically, to a multi-range detection lidar sensor capable of detecting all obstacles within a short distance and a long distance using one lidar sensor.

### Discussion of Related Art

With a trend of developing autonomous driving vehicles and autonomous driving robots, various types of sensors are being used for the purposes of real-time position estimation or obstacle detection.

Among them, lidar sensors are being applied not only to autonomous driving vehicles but also to autonomous driving robots such as robot cleaners and robot serving devices.

As illustrated in FIG. 1, an autonomous driving robot needs a simultaneous localization and mapping (SLAM) function to identify geographical features of a position at which a robot 10 is present to generate a map M and identify a current position on the generated map M and also to identify whether there is an obstacle O in a traveling direction in the map M while traveling.

Accordingly, as illustrated in FIGS. 2A and 2B, a sensor for a long distance detection region is required for map M generation and position estimation and a sensor for a short distance detection region is required for identifying obstacles O.

A long distance sensor 20 with a relatively narrow angle which detects an obstacle O in a long distance region and has a relatively narrow vertical detection angle is required for generating the map M and estimating the position, and a short distance sensor 30 with a wide vertical view angle is required for detecting the obstacle O.

Conventionally, in order to detect obstacles in two detection regions which have different detection distances and require different characteristics of view angles, a long distance lidar sensor and a short distance lidar sensor should be individually provided, which becomes a cause of problems that the complexity of a system and costs increase.

### BRIEF SUMMARY

The present disclosure is directed to providing a multi-range detection lidar sensor capable of detecting obstacles in multiple detection regions using one lidar sensor.

The objects of the present disclosure are not limited to the above-described objects, and other objects that are not mentioned will be clearly understood by those skilled in the art through the following description.

The objects of the present disclosure are not limited to the above-described objects, and other objects that are not mentioned will be able to be clearly understood by those skilled in the art to which the present disclosure pertains from the following description.

In accordance with one aspect of the present disclosure, there is provided a multi-range detection lidar sensor including a laser projector for projecting laser, a laser scanner for refracting the laser projected by the laser projector in any one angle range of a first vertical angle range and a second vertical angle range and scanning the laser, a receiver for receiving the laser projected by the laser projector and reflected by a target, and a controller for controlling the laser projector, the receiver, and the scanner.

The controller may perform control such that a time required for scanning in the first vertical angle range and a time required for scanning in the second vertical angle range are the same.

The controller may perform control such that the first vertical angle range is narrower than the second vertical angle range.

A ground surface may be included in a region detected within the second vertical angle range.

The laser scanner may include a prism for refracting the laser projected by the laser projector and the laser reflected by the target and a liquid crystal metasurface (LCM) which is provided at one side of the prism and adjusts a reflecting angle of the laser projected by the laser projector and reflected and refracted by the prism.

The laser scanner may include any one of a micro electro mechanical systems (MEMS) mirror and a Galvano mirror.

The LCM may be provided at a location at which the laser incident on and totally reflected in the prism is reflected.

The laser projected in the first vertical angle range may detect a long distance target, and the laser projected in the second vertical angle range may detect a short distance target.

The controller may control a long distance detection mode that scans the laser in the first vertical angle range and a short distance detection mode that scans the laser in the second vertical angle range to be sequentially alternately performed or to be non-sequentially alternately performed such that any one detection mode is consecutively performed several times.

The controller may control the long distance detection mode to be performed more than the short distance detection mode when a movement speed of the autonomous driving robot is higher than a set speed or the number of nearby obstacles identified by the lidar sensor is smaller than a set number.

The controller may control the short distance detection mode to be performed more than the long distance detection mode when a movement speed of the autonomous driving robot is lower than a set speed or the number of nearby obstacles identified by the lidar sensor is greater than a set number.

In accordance with another aspect of the present disclosure, there is provided a method of controlling a multi-range detection lidar sensor including a first detection mode in which laser projected by a laser projector is projected in a first vertical angle range and a second detection mode in which the laser projected by the laser projector is projected in the second vertical angle range.

The first vertical angle range in the first detection mode may be narrower than the second vertical angle range in the second detection mode.

A ground surface may be included in the second vertical angle range.

An output power of the laser in the first detection mode and an output power of the laser in the second detection mode may be the same.

A time required for scanning in the first detection mode and a time required for scanning in the second detection mode may be the same.

The first detection mode and the second detection mode may be sequentially alternated, or the first detection mode and the second detection mode may be non-sequentially alternated such that any one detection mode is consecutively performed several times.

The first detection mode may be controlled to be performed more than the second detection mode when the movement speed of the autonomous driving robot is higher than the set speed or the number of nearby obstacles identified by the lidar sensor is smaller than the set number.

The second detection mode may be controlled to be performed more than the first detection mode when the movement speed of the autonomous driving robot is lower than the set speed or the number of nearby obstacles identified by the lidar sensor is greater than the set number.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating one example of a map recognized and generated by a sensor of an autonomous driving robot;

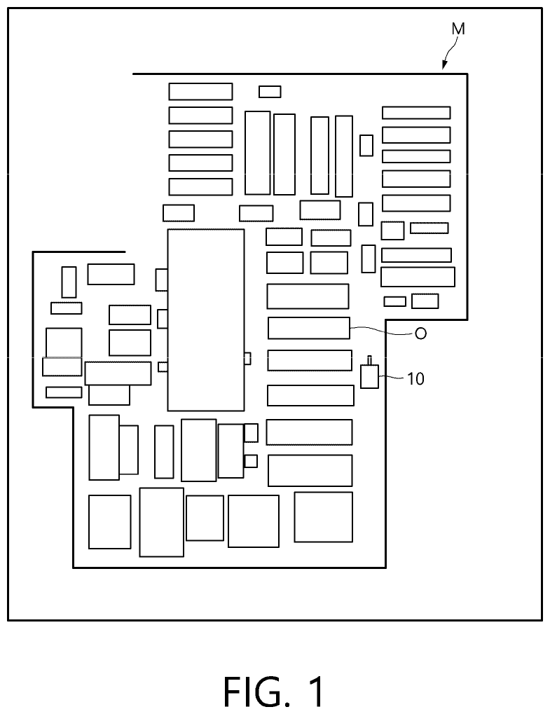

FIG. 2 shows views illustrating detection regions of a lidar sensor applied to the conventional autonomous driving robot;

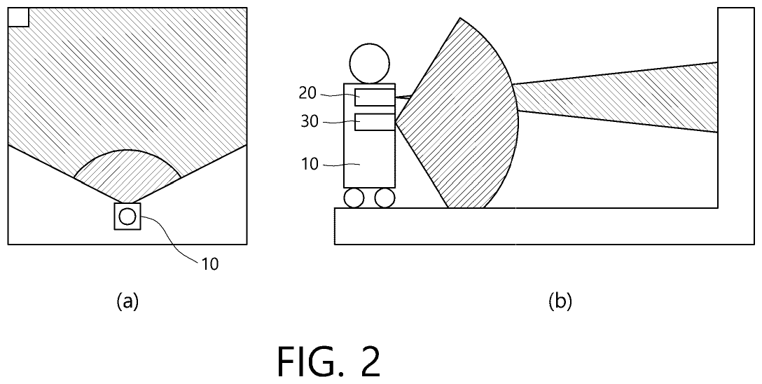

FIG. 3 is a side view illustrating a detection region of a multi-range detection lidar sensor according to one embodiment of the present disclosure;

FIG. 4 is a plan view illustrating the detection region of the multi-range detection lidar sensor according to one embodiment of the present disclosure;

FIG. 5 is a block diagram illustrating a configuration of the multi-range detection lidar sensor according to one embodiment of the present disclosure;

FIG. 6 is a view illustrating an example of a scanner of the multi-range detection lidar sensor according to one embodiment of the present disclosure;

FIG. 7 shows views illustrating other examples of the scanner of the multi-range detection lidar sensor according to one embodiment of the present disclosure;

FIG. 8 shows graphs of a change in vertical scanning range and a change in detection distance over time of the lidar sensor according to one embodiment of a method of controlling a multi-range detection lidar sensor of the present disclosure;

FIG. 9 is a flowchart illustrating an order in which a first detection mode and a second detection mode are alternated according to one embodiment of the method of controlling a multi-range detection lidar sensor of the present disclosure;

FIG. 10 is a flowchart illustrating an order in which a first detection mode and a second detection mode are alternated according to another embodiment of a method of controlling a multi-range detection lidar sensor of the present disclosure; and

FIG. 11 is a flowchart illustrating an order in which a first detection mode and a second detection mode are alternated according to still another embodiment of a method of controlling a multi-range detection lidar sensor of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

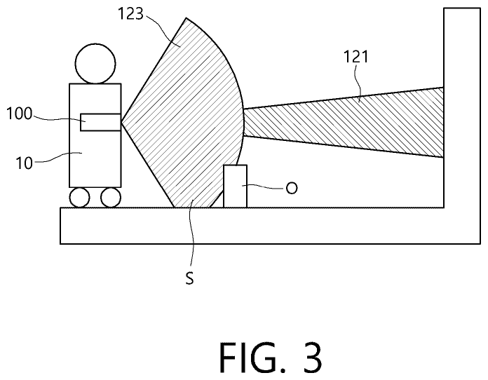

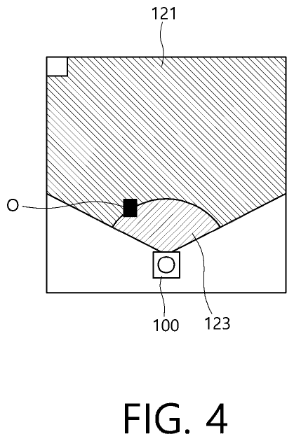

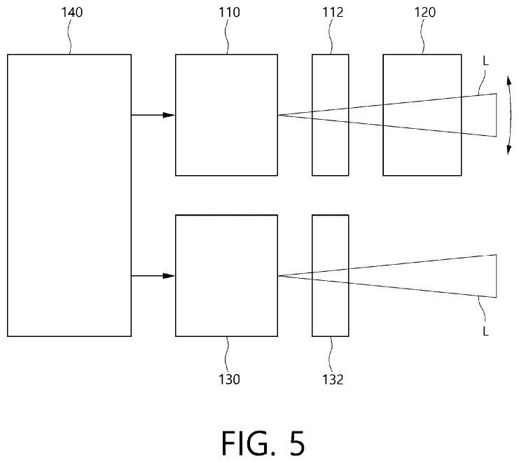

FIG. 3 is a side view illustrating a detection region of a multi-range detection lidar sensor according to one embodiment of the present disclosure, and FIG. 4 is a plan view illustrating the detection region of the multi-range detection lidar sensor according to one embodiment of the present disclosure. In addition, FIG. 5 is a block diagram illustrating a configuration of the multi-range detection lidar sensor according to one embodiment of the present disclosure.

In the description of the present embodiment, an example of a multi-range detection lidar sensor 100 according to the present embodiment mounted on a robot 10 will be described. However, the present disclosure is not necessarily limited thereto, and the multi-range detection lidar sensor 100 may be mounted on another item.

As illustrated in FIGS. 3 to 5, the multi-range detection lidar sensor 100 according to the present embodiment may include a laser projector 110, a laser scanner 120, a receiver 130, and a controller 140.

The laser projector 110 is a component for projecting laser L. The laser projector 110 includes a projection optical system 112, and the laser L projected by the laser projector 110 is properly reflected or refracted by the projection optical system 112 and is incident on the laser scanner 120.

The laser scanner 120 may refract the laser L projected by the laser projector 110 in any one angle range of a first vertical angle range 121 or a second vertical angle range 123 and scan the laser L.

In addition, the receiver 130 is configured to receive the laser L which is projected through the laser projector 110 and the laser scanner 120 and reflected by a target. The receiver 130 may include an optical reception system 132 and receive the laser L reflected or refracted through the optical reception system 132.

In this case, the target may be a wall surface or obstacle O positioned around the robot 10 for generating a map.

The controller 140 may control the laser projector 110, the receiver 130, and the scanner 120.

That is, the controller 140 may control the laser projector 110 to project the laser L and control the scanner to refract the laser L projected by the laser projector 110 in any one angle range of the first vertical angle range 121 and the second vertical angle range 123.

In addition, the controller 140 may analyze data of the laser L received by the receiver 130 to determine whether an obstacle O is present at what angle and what distance.

In this case, the first vertical angle range 121 and the second vertical angle range 123 may be different vertical angle ranges, and the first vertical angle range 121 may have a narrower angle range than the second vertical angle range 123.

Hereinafter, a mode for scanning the first vertical angle range 121 is referred to as a first detection mode, and a mode for scanning the second vertical angle range 123 is referred to as a second detection mode.

A time required for scanning in the first vertical angle range 121 in the first detection mode and a time required for scanning in the second vertical angle range 123 in the second detection mode may be the same.

In addition, an output power of the laser L scanning the first vertical angle range 121 in the first detection mode and an output power of the laser L scanning the second vertical angle range 123 in the second detection mode may be the same.

In addition, horizontal angle ranges for horizontally scanning the laser L in the first detection mode and the second detection mode may be the same. However, horizontal angle ranges scanned in the first detection mode and the second detection mode may be different as necessary.

Accordingly, since the laser L in the first detection mode is projected in a narrower angle range than that in the second detection mode for the same time, the first detection mode may be a long distance detection mode in which a detection distance is greater than that in the second detection mode.

In addition, since the laser L in the second detection mode is projected in a wider angle range than that in the first detection mode for the same time, the second detection mode may be a short distance detection mode in which a detection distance is smaller than that in the first detection mode.

In this case, the controller 140 may control the long distance detection mode and the short distance detection mode to be sequentially alternately performed or control any one of the long distance detection mode and the short distance detection mode to be consecutively performed several times and then changed to the other mode to be non-sequentially alternately performed.

Since the vertical angle range that scans the laser L is narrow but a long distance target may be detected in the long distance detection mode, the long distance detection mode may be used to detect a wall surface and the like to generate a map and estimate a current position, and since a detection distance is short but scanning is possible in a wide vertical angle range in the short distance detection mode, the short distance detection mode may be used to identify the obstacle O which is the short distance target.

In this case, the second vertical angle range 123 that scans the laser L in the short distance detection mode may include a ground surface S on which an autonomous driving robot travels.

That is, one lidar sensor projects the laser L in the long distance detection mode and the short distance detection mode.

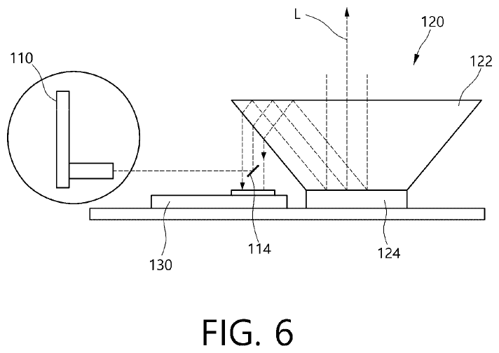

Meanwhile, the laser scanner 120 may have any of various structures. In the present embodiment, as illustrated in FIG. 6, the laser scanner 120 may include a prism 122 and a liquid crystal metasurface (LCM) 124.

That is, as illustrated in FIG. 6, for example, a P-polarization laser L may be projected by the laser projector 110, and the projected laser L may be reflected by the projection optical system 112 such as a mirror 114 toward the prism 122.

The prism 122 may be located on a path along which the laser L projected by the laser projector proceeds, and the LCM 124 may be provided at a location at which the laser L incident on and totally reflected in the prism 122 is reflected.

The laser L may be incident on and refracted by the prism 122 or totally reflected in the prism 122 and reflected by the LCM 124 toward a target. In this case, the LCM 124 may steer the reflected laser L to control a scanning angle range.

In addition, the laser L reflected by the target may be incident on the prism 122, reflected by the LCM 124, totally reflected in and refracted by the prism 122, and then incident on the receiver 130.

The prism 122 is a component formed of a polygonal material through which light is transmitted and in which the laser L may be reflected or refracted. The LCM 124 is provided on the path along which the laser L incident on the prism 122 proceeds. Thus, the prism 122 controls a reflection angle of the laser L which is projected by the laser projector 110 and reflected and refracted by the prism 122 and a reflection angle of the laser L that is reflected by the target and incident on the prism 122.

That is, the LCM 124 adjusts the laser L projected by the laser projector 110 in the first vertical angle range 121 or the second vertical angle range 123.

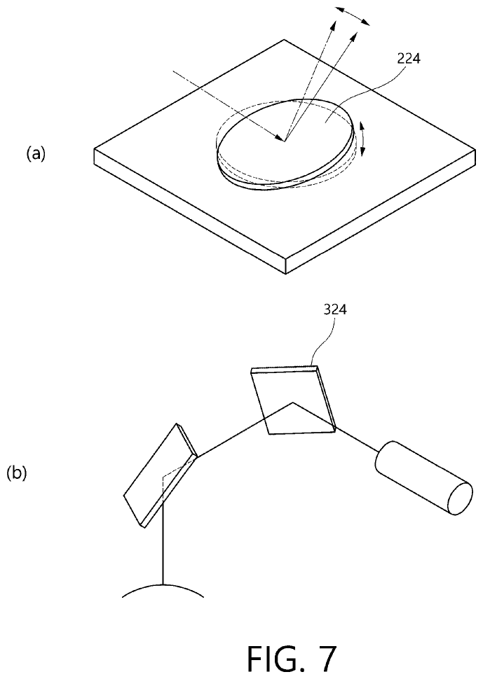

Meanwhile, the laser scanner 120 of the present disclosure may be provided with a micro-electro mechanical systems (MEMS) mirror 224 illustrated in FIG. 7A other than the LCM 124 or with a Galvano mirror 324 illustrated in FIG. 7B instead of or in addition to the LCM 124.

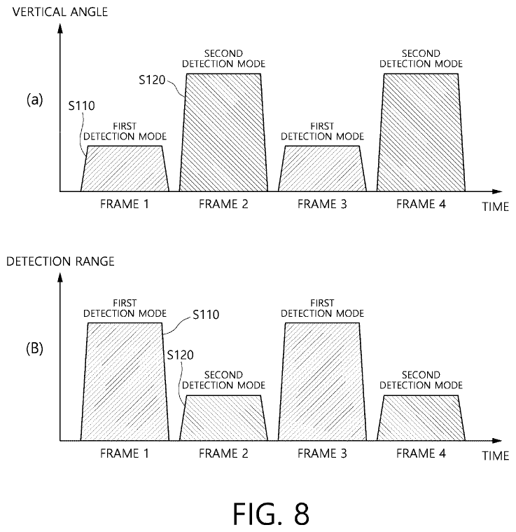

FIG. 8A is a graph showing a change in vertical angle scanning range of the lidar sensor over time, and FIG. 8B is a graph showing a change in detection distance of the lidar sensor over time.

As described above, the controller 140 may control the scanner such that a first detection mode S110 which scans the laser L at a long distance in the first vertical angle range 121 and a second detection mode S120 which scans the laser L at a short distance in the second vertical angle range 123 are sequentially alternately performed.

When a time for which any one of the first detection mode S110 and the second detection mode S120 is performed is defined as a frame, as illustrated in FIG. 8A, a pattern, in which the first detection mode S110 is performed for a frame 1, the second detection mode S120 is performed for a frame 2, the first detection mode S110 is performed again for a frame 3, and the second detection mode S120 is performed for a frame 4, may be repeated.

In addition, as illustrated in FIG. 8B, in the first detection mode S110 for the frame 1, a detection distance may be long, and in the second detection mode S120 for the frame 2, a detection distance may be short. In addition, in the first detection mode S110 for the frame 3, a detection distance may be long again, and in the second detection mode S120 for the frame 4, a detection distance may be short.

Hereinafter, one embodiment of a method of controlling a multi-range detection lidar sensor of the present disclosure will be described.

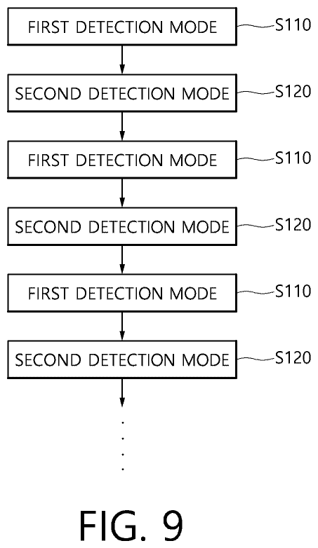

FIG. 9 is a flowchart illustrating the method of controlling the multi-range detection lidar sensor according to one embodiment of the present disclosure.

A method of controlling the multi-range detection lidar sensor 100 according to the present embodiment may include the first detection mode S110 and the second detection mode S120.

The first detection mode S110 is a mode in which the laser L projected by the laser projector is projected in the first vertical angle range 121, and the second detection mode S120 is a mode in which the laser L projected by the laser projector is projected in the second vertical angle range 123.

As described above, the first vertical angle range 121 in the first detection mode S110 may be a vertical angle range that is narrower than the second vertical angle range 123 in the second detection mode S120, a detection distance in the first detection mode S110 may be greater than a second detection distance, a detection distance in the second detection mode S120 may be smaller than a first detection distance, and a region detected within the second vertical angle range 123 in the second detection mode S120 may include the ground surface S.

A time required for scanning in the first vertical angle range 121 in the first detection mode S110 and a time required for scanning in the second vertical angle range 123 in the second detection mode S120 may be the same.

In addition, an output power of the laser L scanning the first vertical angle range 121 in the first detection mode S110 and an output power of the laser L scanning the second vertical angle range 123 may be the same.

In addition, horizontal angle ranges for horizontally scanning the laser L in the first detection mode S110 and the second detection mode S120 may be the same.

As illustrated in FIG. 9, in the present embodiment, the first detection mode S110 and the second detection mode S120 may be sequentially alternately performed.

That is, the second detection mode S120 may be performed right after the first detection mode S110 is perform, the first detection mode S110 may be performed right after the second detection mode S120 is performed, and such a pattern may be repeated to evenly perform the first detection mode S110 which is the long distance detection mode and the second detection mode S120 which is the short distance detection mode.

However, the present disclosure is not limited thereto, and the first detection mode S110 and the second detection mode S120 may be unevenly performed.

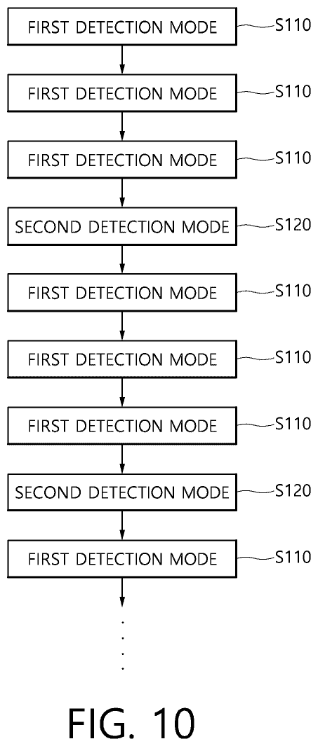

FIG. 10 is a flowchart illustrating a method of controlling a multi-range detection lidar sensor 100 according to another embodiment of the present disclosure.

As illustrated in FIG. 10, in the method of controlling the multi-range detection lidar sensor 100 according to another embodiment of the present disclosure, a pattern, in which the second detection mode S120 is performed after the first detection mode S110 is performed a plurality of times and the second detection mode S120 is performed after the first detection mode S110 is performed a plurality of times, may be repeated.

In this case, in the present embodiment, an example in which the number of times that the first detection mode S110 is performed is two or three is described, but the present disclosure is not necessarily limited thereto. The second detection mode S120 is not limited to be performed one time and may be performed a plurality of times as long as the number of times that the second detection mode S120 is performed is smaller than that of the first detection mode S110.

The method of controlling may be performed when there are no or few nearby obstacles O identified by the lidar sensor, a movement speed of an autonomous driving robot 10 is high, or it is difficult to generate a map and estimate a current position.

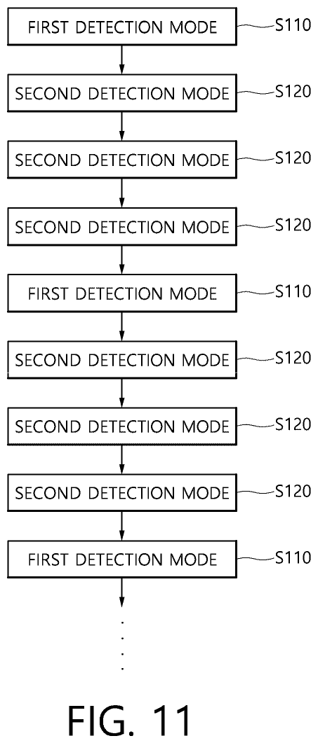

FIG. 11 is a flowchart illustrating a method of controlling a multi-range detection lidar sensor 100 according to still another embodiment of the present disclosure.

As illustrated in FIG. 11, in the method of controlling the multi-range detection lidar sensor 100 according to still another embodiment of the present disclosure, a pattern, in which the second detection mode S120 is performed a plurality of times after the first detection mode S110 is performed and the second detection mode S120 is performed a plurality of times after the first detection mode S110 is performed, may be repeated.

In this case, in the present embodiment, an example in which the number of times that the second detection mode S120 is performed is two or three is described, but the present disclosure is not necessarily limited thereto. The first detection mode S110 is not limited to be performed one time and may be performed a plurality of times as long as the number of times that the first detection mode S110 is performed is smaller than that of the second detection mode S120.

Such a controlling method may be performed when there are many nearby obstacles O identified by the lidar sensor, or a movement speed of an autonomous driving robot 10 is low.

Since one lidar sensor according to the present disclosure can perform long distance detection and short distance detection, a plurality of sensors do not need to be provided and only one lidar sensor can be used. Therefore, there are effects that the number of lidar sensor devices and costs decrease, space and wiring required for mounting lidars are minimized, and the complexity in a system is reduced.

In addition, there is an effect of a flexibly respond to requirements of various vertical view angles required for various autonomous driving robot applications.

It should be understood that the effects of the present disclosure are not limited to the above-described effects, and include all effects inferable from the detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

1. A multi-range detection lidar sensor comprising:
a laser projector that projects laser;
a laser scanner that refracts the laser projected by the laser projector in any one angle range of a first vertical angle range and a second vertical angle range and scans the laser;
a receiver that receives the laser projected by the laser projector and reflected by a target; and
a controller that controls the laser projector, the receiver, and the scanner.

2. The multi-range detection lidar sensor of claim 1, wherein the controller performs control such that a time required for scanning in the first vertical angle range and a time required for scanning in the second vertical angle range are the same.

3. The multi-range detection lidar sensor of claim 1, wherein the controller performs control such that the first vertical angle range is narrower than the second vertical angle range.

4. The multi-range detection lidar sensor of claim 3, wherein a ground surface is included in a region detected within the second vertical angle range.

5. The multi-range detection lidar sensor of claim 1, wherein the laser scanner includes:
a prism that refracts the laser projected by the laser projector and the laser reflected by the target; and
a liquid crystal metasurface (LCM) which is provided at one side of the prism and adjusts a reflecting angle of the laser projected by the laser projector and reflected and refracted by the prism.

6. The multi-range detection lidar sensor of claim 1, wherein the laser scanner includes any one of a micro electro mechanical systems (MEMS) mirror and a Galvano mirror.

7. The multi-range detection lidar sensor of claim 5, wherein the LCM is provided at a location at which the laser incident on and totally reflected in the prism is reflected.

8. The multi-range detection lidar sensor of claim 3, wherein:
the laser projected in the first vertical angle range detects a long distance target; and
the laser projected in the second vertical angle range detects a short distance target.

9. The multi-range detection lidar sensor of claim 1, wherein the controller controls a long distance detection mode that scans the laser in the first vertical angle range and a short distance detection mode that scans the laser in the second vertical angle range to be sequentially alternately performed or to be non-sequentially alternately performed such that any one detection mode is consecutively performed several times.

10. The multi-range detection lidar sensor of claim 9, wherein the controller controls the long distance detection mode to be performed more than the short distance detection mode when a movement speed of a autonomous driving robot is higher than a set speed or the number of nearby obstacles identified by the lidar sensor is smaller than a set number.

11. The multi-range detection lidar sensor of claim 9, wherein the controller controls the short distance detection mode to be performed more than the long distance detection mode when a movement speed of an autonomous driving robot is lower than a set speed or the number of nearby obstacles identified by the lidar sensor is greater than a set number.

12. A method of controlling the multi-range detection lidar sensor of claim 1, the method comprising:
a first detection mode in which laser projected by a laser projector is projected in a first vertical angle range; and
a second detection mode in which the laser projected by the laser projector is projected in a second vertical angle range.

13. The method of claim 12, wherein the first vertical angle range in the first detection mode is narrower than the second vertical angle range in the second detection mode.

14. The method of claim 13, wherein a ground surface is included in a region detected within the second vertical angle range.

15. The method of claim 12, wherein an output power of the laser in the first detection mode and an output power of the laser in the second detection mode are the same.

16. The method of claim 12, wherein a time required for scanning in the first detection mode and a time required for scanning in the second detection mode are the same.

17. The method of claim 12, wherein the first detection mode and the second detection mode are sequentially alternated or non-sequentially alternated such that any one detection mode is consecutively performed several times.

18. The method of claim 12, wherein the first detection mode is controlled to be performed more than the second detection mode when the movement speed of an autonomous driving robot is higher than the set speed or the number of nearby obstacles identified by the lidar sensor is smaller than the set number.

19. The method of claim 12, wherein the second detection mode is controlled to be performed more than the first detection mode when the movement speed of an autonomous driving robot is lower than the set speed or the number of nearby obstacles identified by the lidar sensor is greater than the set number.
